(19) United States
(12) Patent Application Publication
(10) Pub. No.: US 2015/0023498 A1
(43) Pub. Date: Jan. 22, 2015

(54) BYZANTINE FAULT TOLERANCE AND THRESHOLD COIN TOSSING

(71) Applicant: KONINKLIJKE PHILIPS N.V., EINDHOVEN (NL)

(72) Inventors: Muhammad Asim, Eindhoven (NL); Klaus Kursawe, Eindhoven (NL)

(73) Assignee: KONINKLIJKE PHILIPS a corporation

(21) Appl. No.: 14/382,877

(22) PCT Filed: Mar. 7, 2013
(86) PCT No.: PCT/IB2013/051815

§ 371 Date: Sep. 4, 2014

Related U.S. Application Data
(60) Provisional application No. 61/609,524, filed on Mar. 12, 2012.

(51) Int. Cl. H04L 9/08

(52) U.S. Cl. CPC H04L 9/0816; H04L 9/0861; H04L 2209/24
USPC 380/44

(57) ABSTRACT

A coin share generator (5) is employed in a system for performing a threshold coin tossing scheme. The coin share generator (5) comprises a coin determining unit (6) for determining a coin value, and a coin share generating unit (7) for generating a coin share based on a coin value and a private key associated with a set of attributes, to obtain a coin share associated with the set of attributes. The system further comprises a coin share verifier (8) that has a coin share determining unit (9) for determining a coin share to be verified, wherein the coin share is associated with a set of attributes, and a coin share verifying unit (10) for verifying a validity of the coin share, taking into account the set of attributes associated with the coin share.

### FIELD OF THE INVENTION

The invention relates to a coin share generation. The invention further relates to a coin share verification. The invention further relates to performing a byzantine fault tolerance protocol.

### BACKGROUND OF THE INVENTION

In recent times, the interest in cloud computing has increased significantly due to the benefits that it promises. In cloud computing, computing services are readily available on demand, similar to utility services that could be availed on demand. Users no longer need to invest heavily or encounter difficulties in building and maintaining complex IT infrastructure. In such a model, users may access services based on their needs regardless of where the services are hosted. Cloud computing can be classified as a new paradigm for the dynamic provisioning of computing services, typically supported by state-of-the-art data centers containing ensembles of networked Virtual Machines. Cloud computing delivers infrastructure, platform, and software (application) as services. These are referred to as, respectively, Infrastructure as a Service (IaaS), Platform as a Service (PaaS), and Software as a Service (SaaS).

Clouds may provide improved next generation data centers by architecting them as a network of virtual services (hardware, database, user-interface, application logic), so that users are able to access and deploy applications from anywhere in the world on demand at competitive costs depending on the user's desired QoS (Quality of Service) level. Developers with innovative ideas for new Internet services no longer need large capital outlays in hardware to deploy their service or human expense to operate it. It offers significant benefits to IT companies by freeing them from the low level task of setting up basic hardware (servers) and software infrastructures, thus enabling them to focus more on innovation and on creating business value for their services.

In order to support a large number of users from around the world, cloud infrastructure providers (i.e., IaaS providers) have established data centers in multiple geographical locations to provide redundancy and ensure reliability in case of site failures.

Although cloud computing provides a number of benefits there are still a lot of challenges related to the availability, reliability and security that need to be addressed.

Byzantine fault tolerance (BFT) has been studied as a mechanism to improve availability and security of practical systems. One of the applications of BFT is in cloud computing, in particular critical services deployed in a cloud. For example, a service might be hosted by multiple independent cloud providers, such that it tolerates faults in a subset of the clouds. BFT protocols use threshold coin tossing schemes as a means to enhance fault tolerance. A threshold coin tossing scheme allows managing faults based on the identity of the participants in the scheme. The public key size used in threshold coin tossing increases with the number of parties.

“Our Data, Ourselves: Privacy via Distributed Noise Generation”, by C. Dwork et al., in Proceedings Eurocrypt, 2006, pages 486-503, Springer, discloses distributed protocols for generating shares of random noise, secure against malicious participants. Privacy in databases is obtained by perturbing the true answer to a database query by the addition of a small amount of Gaussian or exponentially distributed random noise. A distributed implementation eliminates the need for a trusted database administrator.

### SUMMARY OF THE INVENTION

It would be advantageous to have an improved system for performing a threshold coin tossing scheme. To better address this concern, a first aspect of the invention provides a coin share generator for use in a system for performing a threshold coin tossing scheme. The coin share generator comprises:

a coin determining unit arranged for determining a coin value;

a coin share generating unit arranged for generating a coin share based on a coin value and a private key associated with a set of attributes, to obtain a coin share associated with the set of attributes.

By associating a coin share with a set of attributes, it becomes possible to perform a threshold coin tossing scheme that allows participating parties that have predetermined attributes. It is not necessary to use identification-based cryptography. One of the advantages of managing the faults based on the attributes is a reduction of public key size as the same attribute may be possessed by multiple parties. Further, this also allows managing the entities based on a policy over a list of attributes. The proposed coin share generator allows the generation of a coin share associated with a set of attributes. Because of this, verification and reconstruction of the coin share by a verification unit based on a policy on the attributes of the parties, becomes possible.

The coin share generating unit may be arranged for generating a coin share that enables a receiving entity to reconstruct the coin, based on a particular threshold number of coin shares associated with a set of attributes that satisfies a predetermined policy over the attributes. This way, the attributes can be used instead of the identity of the sender to reconstruct the coin. This reduces or eliminates the burden of maintaining public keys for different users' identities.

In another aspect, the invention provides a coin share verifier for use in a system for performing a threshold coin tossing scheme. The coin share verifier comprises:

a coin share determining unit arranged for determining a coin share to be verified, wherein the coin share is associated with a set of attributes; and

a coin share verifying unit arranged for verifying a validity of the coin share, taking into account the set of attributes associated with the coin share.

Such a coin share verifier can assess the validity of coin shares based on their associated attributes. This may reduce the size of public key data needed, as the attributes may be re-used among several entities. Moreover, the key handling is simplified because the coin share verifier does not need to keep track of users' privileges, because these privileges may be represented by the attributes of such users.

The coin share verifying unit may comprise an attribute verification unit arranged for verifying that the coin share is validly associated with a particular attribute. A coin share may be thought to be associated with a particular set of attributes, for example because the coin share contains a list of associated attributes. The attribute verification unit helps to verify that the coin share is validly associated with these attributes, for example using attribute-based cryptography, because it allows to verify whether the coin share is associated with a particular attribute.

The coin share verifier may comprise a policy determiner arranged for determining a policy over a collection of attributes, wherein the set of attributes comprises a subset of the collection of attributes; and wherein the coin share verifying unit is further arranged for verifying whether the coin share is associated with a set of attributes that satisfies the policy. It may be the case that different sets of attributes are acceptable for a favorable validation of the coin share. The constraints that define what is an acceptable set of attributes may be represented by means of a policy over the collection of attributes in the system. This allows a compact representation of coin share verifier parameters and/or enables a flexible configuration of the coin share verifier.

The coin share verifier may comprise a share combining unit arranged for reconstructing the coin by combining at least a predetermined threshold number of coin shares, wherein the coin shares are associated with respective sets of attributes that satisfy a predetermined policy over the attributes. Not all the coin shares need to be associated with the same set of attributes for a successful reconstruction of the coin. However, the coin shares should be associated with respective sets of attributes that satisfy the policy over the collection of attributes.

The share combining unit may comprise a coin share reconstructing unit for removing the attributes from the coin shares, to obtain reconstructed coin shares. These reconstructed coin shares have been cryptographically processed, so that any encryption or encoding due to the attribute-based cryptography of the coin share is removed. This makes it easier to combine the coin shares to reconstruct the coin.

The coin share may comprise an identification of the set of attributes associated with the coin share. This facilitates processing by the verifier. Moreover, the coin share may be cryptographically processed using attribute-based cryptography. This allows verification by the verifier with a high level of system security.

In another aspect, the invention provides a system for performing a byzantine fault tolerance protocol. This system comprises a coin share generator as set forth herein. Additionally or alternatively, the system comprises a coin share verifier set forth herein.

The system may further comprise a root authority subsystem comprising

an attribute selector for selecting the set of attributes of a user;

a key generating unit for generating the private key associated with the set of attributes; and

a key distributor for providing the private key to the coin share generator.

This allows the coin share generator to generate the coin share associated with the set of attributes of the user of the coin share generator.

A workstation or a mobile terminal may be provided that comprises a coin share generator as set forth herein, a coin share verifier as set forth herein, and/or a system for performing a byzantine fault tolerance protocol as set forth herein.

In another aspect, the invention provides a method of generating a coin share in a threshold coin tossing scheme, comprising

determining a coin value; and

generating a coin share based on a coin value and a private key associated with a set of attributes, to obtain a coin share associated with the set of attributes.

In another aspect, the invention provides a method of verifying a coin share in a threshold coin tossing scheme, comprising

determining a coin share to be verified, wherein the coin share is associated with a set of attributes; and

verifying a validity of the coin share, taking into account the set of attributes associated with the coin share.

The method may further comprise reconstructing the coin by combining at least a predetermined threshold number of coin shares, wherein the coin shares are associated with respective sets of attributes that satisfy a predetermined policy over the attributes.

In another aspect, the invention provides a computer program product comprising instructions for causing a processor system to perform one or more of the methods set forth.

It will be appreciated by those skilled in the art that two or more of the above-mentioned embodiments, implementations, and/or aspects of the invention may be combined in any way deemed useful.

Modifications and variations of the image acquisition apparatus, the workstation, the system, the method, and/or the computer program product, which correspond to the described modifications and variations of the system, can be carried out by a person skilled in the art on the basis of the present description.

### BRIEF DESCRIPTION OF THE DRAWINGS

These and other aspects of the invention are apparent from and will be elucidated with reference to the drawings.

FIG. 1 is a block diagram of a system for performing a threshold coin tossing scheme.

FIG. 2 is a flowchart of a method of performing a threshold coin tossing scheme.

### DETAILED DESCRIPTION OF EMBODIMENTS

One way of describing a threshold coin tossing scheme is by describing a set of algorithms that can be employed by different actors in the scheme. These algorithms may be implemented on devices that are under control of these different actors.

An example set of algorithms is the following.

Setup( ): This algorithm may be run by a root authority (RA) and, in some embodiments, does not need to take any parameters as input. However, some parameters may be implicitly defined by the design of the system. Such parameters may include the field used to perform the computations. The setup algorithm may generate as outputs a set of public parameters PK and a master secret key MK. The master secret key MK may be used in the key generation algorithm for the generation of private keys.

Key Generation (M K,ω): This algorithm may be run by the root authority. Alternatively, it may be run by a separate key distributing entity. The key generation algorithm takes as input the master secret key MK and an attribute set ω possessed by party Pᵢ. The output of this algorithm is a secret key SK_{ω,P}_{ᵢ} associated with attribute set ω.

Generate Coin Share (C,SK_{ω,P}_{ᵢ}): This algorithm may be run on a computing environment that is controlled by one of the parties, for example party Pᵢ. This algorithm takes as input the coin C ε{0,1}* and the party Pᵢ's secret key SK_{ω,P}_{ᵢ}. This secret key SK_{ω,P}_{ᵢ} is associated with the attribute set ω. The output of this algorithm is a share of the coin C. However, this share of the coin C is processed using attribute-based cryptography, for example digitally signed with the set of attributes ω, so that a receiving party can verify that the share is associated with the attribute set ω possessed by Pᵢ.

Share Verification (PK, σ_{ω,P}_{ᵢ}): This algorithm takes as input the public key PK and a share of the coin σ_{ω,P}_{ᵢ} from party Pᵢ. It determines whether the coin share is valid. For example, it determines whether the coin share is validly signed with an appropriate set of attributes.

Share Combining (σ_{ω,P}_{ᵢ}): The share combining algorithm takes as input the valid shares of the coin C signed using attribute set ω. It may output the original value of the coin if a sufficiently large number of shares of the coin is available.

An attribute-based threshold coin tossing scheme may be provided wherein the coin share is generated according to a policy over attributes. The secret key components related to the attributes of a party may be issued by a dealer, for example a root authority. After issuing these keys, the dealer does not necessarily have any further role to play in the interaction protocol. Similar to the regular threshold coin tossing scheme, a correct coin may only be constructed if there are enough parties, say “t” out of “n”, that have provided a valid coin share. However, in the attribute-based threshold coin tossing scheme, these coin shares need to be associated with an appropriate list of attributes.

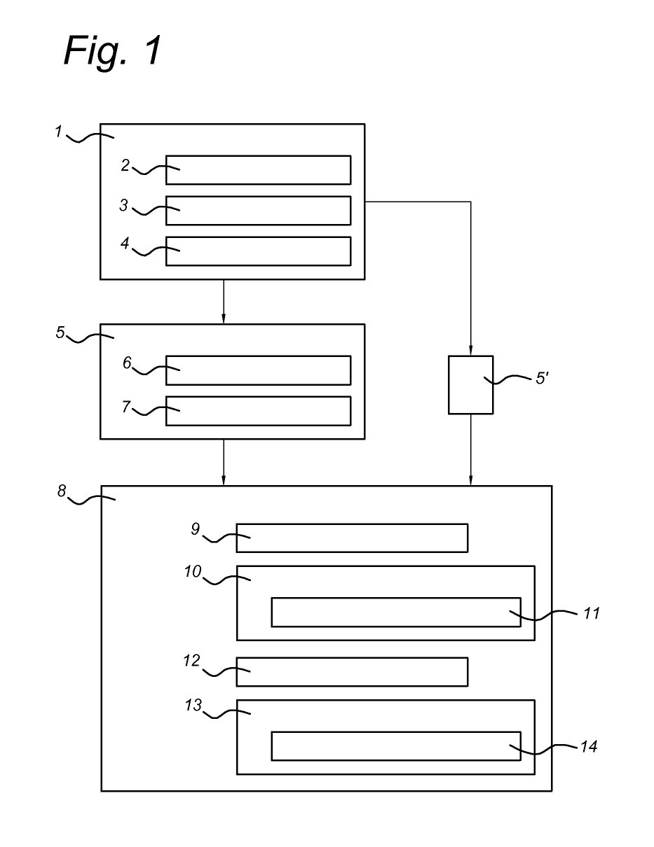

FIG. 1 illustrates an example of a system that comprises a number of entities that can perform a threshold coin tossing scheme. The system comprises a root authority subsystem 1, a coin share generator 5, and a coin share verifier 8. A second coin share generator 5′ is also drawn to illustrate that there typically is more than one coin share generator. There may also be more than one coin share verifier in the system. However, this is not shown in the drawing. A plurality of coin share generators 5,5′ may generate their respective coin shares and send them to the same coin share verifier 8 for validation and reconstruction of the coin.

The root authority subsystem 1 may comprise an attribute selector 2 for selecting the set of attributes of a user. Such an attribute selector 2 may be operatively coupled with other elements of the system that are not shown in the drawing. For example, the attribute selector 2 may have access to a protected user database that stores information relating to different users of the system. The attribute selector 2 may be arranged for selecting the set of attributes of a user in dependence on the information about that user in the database. Additionally or alternatively, the attribute selector 2 may comprise a user interface that enables a user to choose one or more of the attributes.

The root authority subsystem 1 may further comprise a key generating unit 3 for generating a private key associated with the set of attributes selected by the attribute selector 2. This private key may be an attribute-based encryption key or an attribute-based digital signature key, for example. More details of an example of such a key are provided hereinafter.

The root authority subsystem 1 may further comprise a key distributor 4 for providing the private key to the coin share generator. This key distributor may be operatively connected to a network, such as the Internet or a private network, for transmitting the private key to the legitimate user of that key. The key distributor may also be arranged for simply outputting the key, so that a human operator may physically deliver the key to the user of the key.

The coin share generator 5 may be arranged for generating the coin share. To this end, the coin share generator may comprise a coin determining unit 6 arranged for determining a coin value. This coin value may be a value that should be conveyed to a receiving party. The coin determining unit 6 may be arranged for receiving the coin value from an external program, subroutine, or database. The coin determining unit 6 may also be arranged for determining the coin value based on a user input. Other ways of determining the coin value are apparent to the person skilled in the art of conventional threshold coin tossing algorithms and Byzantine fault tolerance systems.

The coin share generator 5 may further comprise a coin share generating unit 7 for generating a coin share based on the coin value and a private key associated with a set of attributes. This private key is typically received from the root authority subsystem 1. The coin share that is generated comprises a representation of at least part of the coin value. However, a sufficient number of coin shares is needed to be able to establish the authenticity of the coin value and/or to reconstruct the coin value. Moreover, the coin share generator 5 is arranged to generate the coin share in such a way that the coin share is associated with the set of attributes. This association can be performed, for example, using an attribute-based cryptography and/or signature algorithm.

The coin share generating unit 7 may be arranged for generating a coin share that enables a receiving entity to reconstruct the coin based on a particular threshold number of coin shares associated with a set of attributes that satisfies a predetermined policy over the attributes. Typically, the different coin shares used in a reconstruction are generated by different coin share generators 5, 5′.

The coin share verifier 8 may comprise a coin share determining unit 9 for determining a coin share to be verified, wherein the coin share is associated with a set of attributes. For example, the coin share determining unit 9 is connected to the coin share generators 5, 5′ via a network connection. This would allow the coin share determining unit 9 to receive the coin shares from the coin share generators 5, 5′ via the network. Alternatively, a separate program or device may be arranged to receive the coin shares and store them in a database under control of the coin share verifier 8. Other ways to transfer the coin shares from the coin share generators 5, 5′ to the coin share verifier 8 will be apparent to the person skilled in the art.

The coin share verifier 8 may further comprise a coin share verifying unit 10 for verifying a validity of the coin share, taking into account the set of attributes associated with the coin share. The coin share verifying unit 10 thus verifies the authenticity of the coin share in relation to the set of attributes that the coin share is thought to be associated with. The coin share verifying unit may be arranged for extracting the set of attributes from the coin share itself. For example, the coin share may comprise a plain-text representation of its associated set of attributes. Alternatively, the coin share verifier has access to a list of attributes for each of the senders. The authenticity of these attributes may be checked cryptographically by the coin share verifier 8.

The coin share verifying unit 10 may comprise an attribute verification unit 11 arranged for verifying that the coin share is validly associated with a particular attribute. For example, the coin share verifying unit may be arranged for activating the attribute verification unit 11 repeatedly for the attributes that it needs to verify.

The coin share verifier 8 may further comprise a policy determining unit 12 for determining a policy over a collection of attributes, wherein the set of attributes comprises a subset of the collection of attributes. In attribute-based systems, usually there is defined a universe of attributes. This universe of attributes is herein referred to as the collection of attributes. A policy can be expressed by specifying which combinations of attributes are acceptable for a coin share. The policy determining unit 12 determines the policy. The particulars of this policy may be imposed by external considerations, such as the privileges of the different parties involved in the system. The policy determining unit 12 may be arranged for receiving the policy from another entity, or for receiving the policy by means of a user input, or by a predefined setting. The policy determining unit 12 may provide the policy to the coin share verifying unit 10, so that the latter can verify whether the coin shares satisfy the policy. The same policy may be imposed on all coin shares, or different policies may be allowed for different coin shares.

The coin share verifier 8 may comprise a share combining unit 13 for reconstructing the coin value by combining at least a predetermined threshold number of coin shares. These coin shares may be associated with respective sets of attributes that satisfy a predetermined policy over the attributes. A two-step approach may be employed, although this is not a limitation. In the two-step approach, first the attributes are removed from the coin shares. This presupposes that the coin share generator 5 is arranged for adding the attributes as a “wrapper” around a “bare” coin share. This “bare” coin share may be generated and combined in a way similar to the generation and combining of coin shares in existing threshold coin sharing schemes. To support this two-step approach, the share combining unit 13 may comprise a coin share reconstructing unit 14 for removing the attributes from the coin shares, to obtain reconstructed coin shares.

It will be understood that the coin share may comprise an identification of the set of attributes associated with the coin share, for example a listing of the attributes in an unencrypted representation. Moreover, the coin share may be cryptographically processed using attribute-based cryptography. This cryptographic processing may be applied to the entire coin share, or to only a portion of it. The cryptographic processing may comprise attribute-based encrypting/decrypting and/or attribute-based signature generation and verification. Consequently, a coin share may comprise an encrypted portion and/or a digitally signed portion, according to the set of attributes of the coin share generator 5.

The system for performing an attribute-based threshold coin tossing scheme may be adapted to and/or included in a system for performing a byzantine fault tolerance protocol. The skilled person is capable to perform the adaptations needed for this based on this disclosure.

The different algorithms and entities disclosed therein may be implemented by means of devices comprising dedicated electronic circuitry for performing the described functionality. Alternatively, they may be implemented by means of a suitably programmed processing device. Such a processing device can be a workstation or personal computer, or a mobile device, such as a tablet or smartphone. They may also be hosted ‘in the cloud’, on a server system that is connected to the Internet. Users may access such hosted applications using client devices, for example via a web browser. In all cases, the use of the algorithms may be protected against malicious use. For example, user access control can be imposed on the units implementing key portions of the protocol.

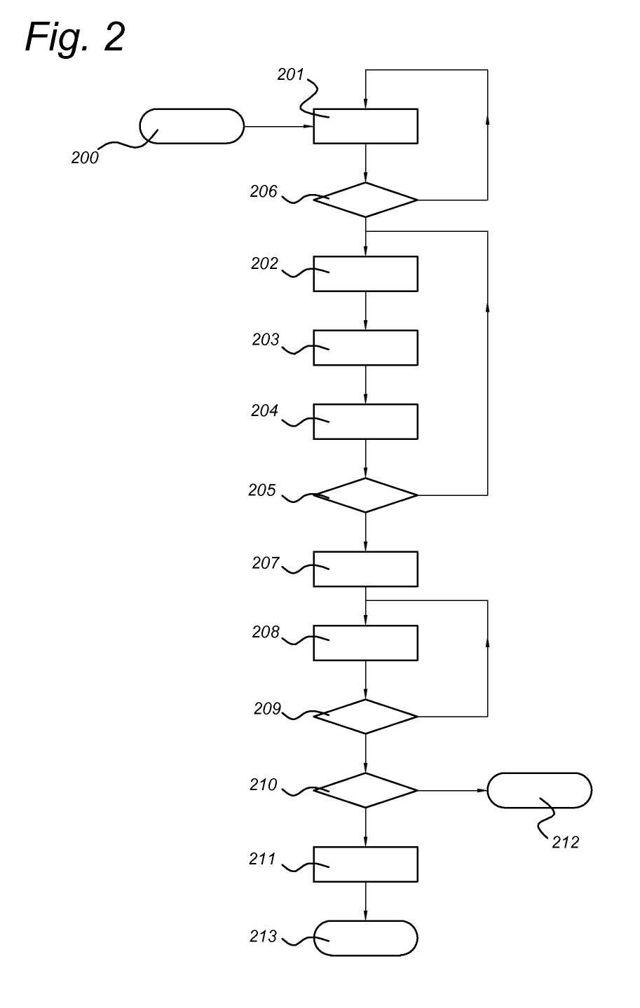

FIG. 2 shows an illustrative method of generating a coin share in a threshold coin tossing scheme. The method starts at step 200. The method comprises a preparation step 201 that involves selecting a set of attributes for a user, generating a private key associated with the set of attributes for the user, and providing the private key to the user or the user's coin share generator. In step 206, it is determined whether a private key is needed for another user, and if so, step 201 is repeated.

In step 202, a coin value is determined. In step 203, a coin share is generated to represent at least part of the coin value. The coin share is associated with the set of attributes of the user, and created using the private key provided. The coin share may be transmitted in step 204 to a recipient. The recipient may have a coin share verifier as set forth herein. Steps 202 to 204 may be performed by a coin share generator set forth herein. In step 205, if a coin share from another coin share generator is needed, steps 202 to 204 may be repeated using another coin share generator, using the other coin share generator's private key, but the same coin value.

In step 207, a coin share to be verified is determined. For example, the coin share is received from the coin share generator that generated it. In step 208, the validity of the coin share is determined, taking into account the set of attributes associated with the coin share. If more coin shares are found to be available in step 209, steps 207 and 208 may be repeated in respect of the remaining coin shares. In step 210, it is decided whether the number of valid shares is at least equal to a predetermined threshold. If the number of valid shares is smaller than the predetermined threshold, the process terminates at step 212. Alternatively, if the number of valid shares is at least equal to the threshold value, the coin value may be reconstructed in step 211 by combining at least a predetermined threshold number of coin shares. After that, the process terminates in step 213.

The method may be implemented by means of a computer program product comprising instructions for causing a processor system to perform the method. This computer program product may be split up into several units that are run on different computer systems, under control of several different parties using the system.

Hereinafter, examples of the algorithms used in the system and method are described in more detail. These algorithms are part of an attribute-based threshold coin-tossing scheme. It will be understood that these details are intended as non-limiting example implementations. At a high level, the scheme works as follows: The value of coin C ε{0,1}* is obtained by first hashing C to obtain ǵ ε [symbol] ₀, then computing e(\tilde{g},g)^{x}^{₀} to obtain the value of the coin that belongs to the group [symbol] ₁. The secret exponent x₀ is distributed among the parties denoted by Pᵢ with the attribute set ω using Shamir's secret sharing scheme. In addition to the share of x₀, each party also has the secret keys related to the attribute set ω. Using share of x₀ i.e. xᵢ and secret key components i.e. H(j)^{r}^{ⱼ}^{+α·x}^{ᵢ}:∀j εω, share of the coin is generated, along with a validity proof. Shares of the coin can then be combined to obtain e(\tilde{g},g)^{x}^{₀} by interpolation in the exponent.

Setup ( ): The setup algorithm selects a bilinear group [symbol] ₀ of prime order p and random generator ε [symbol] ₀. In addition, it also employs a hash function H: {0,1}*→ [symbol] ₀. The function is used to map any attribute described as a binary string to a random group element. It also chooses a bilinear map e: [symbol] ₀× [symbol] ₀→ [symbol] _{T}. The setup algorithm selects α, rⱼε [symbol] ₚ, where 1≦j≦N and N being the total number of attributes in the system. The public parameters PK and master secret key MK consist of the following components:

PK=g^{α},{g^{r}^{ⱼ}}ⱼ₌₁^{N},MK=α,{rⱼ}ⱼ₌₁^{N}

Key Generation (MK, ω_{P}_{ᵢ}): The key generation algorithm is run by central trusted authority. It takes as input a set of attributes ω for party Pᵢ, master secret key MK and outputs secret key for the user related to the attribute set ω. The algorithm selects xᵢ=f (i) for each party Pᵢ, where f is a polynomial over [symbol] _{q} of degree less then k. It then generates secret key for the party Pᵢ related to the attribute set ωwhich consists of the following components:

SK_{ω,P}_{ᵢ}=(∀jεω:Dⱼ⁽¹⁾=H(j)^{r}^{ⱼ}^{+α·x}^{ᵢ},D⁽²⁾=xᵢ)

Generate Coin Share (SK_{ω,P}_{ᵢ}): For a general coin C ε {0,1}, let \tilde{g}=H (C). The coin share for a party Pᵢ along with its validity proof is generated using SK_{ω,P}_{ᵢ}, which consists of the following components:

σ_{ω,P}_{ᵢ}=(σⱼ⁽¹⁾=\tilde{g}^{x}^{ᵢ}·H(j)^{r}^{ⱼ}^{+α·x}^{ᵢ}:∀jεω,σ⁽²⁾=g^{x}^{_{i,}}σ⁽³⁾=H(j)^{x}^{ᵢ})

Note: In this function, one could use shares of the value xᵢ during the generation of the coin share using for example a threshold secrete sharing scheme instead of the value of the xᵢ.
Share Verification (PK,σ_{ω,P}_{ᵢ}): The share verification algorithm takes as input the public parameters and share of the coin σ_{ω,P}_{ᵢ} generated by the party Pᵢ using the attribute set ω.

e(σⱼ⁽¹⁾,g)=e(g^{r}^{ⱼ},H(j))·e(σ⁽³⁾,g^{α})·e(\tilde{g},σ⁽³⁾):∀jεω

e(\tilde{g}^{x}^{ᵢ}·H(j)^{r}^{ⱼ}^{+α·x}^{ᵢ},g)=e(g^{r}^{ⱼ},H(j))·e(H(j)^{x}^{ᵢ},g^{α})·e(\tilde{g},g^{x}^{ᵢ}):∀jεω

The above routine may be applied to the shares of the coin of all parties Pᵢ(1≦i≦n), where n is the total number of parties in the system.

Share Combining (94_{ω,P}_{ᵢ}): The share combining algorithm first reconstructs the share of the coin for all parties Pᵢ. After the reconstruction of the coin shares, it recovers the final value of the coin.
(a) Step 1-Reconstruct_{ShareOfCoin} (Pᵢ): This routine is used to construct the share of the coin of each party Pᵢ. Let ρ be the list of the claimed attributes by the party Pᵢ.

$$\begin{matrix}{Z}^{( {P}_{i} )} = {( {\prod }_{j ∈ ρ} ( \frac{e ( {\tilde{g}}^{{x}_{i}} \cdot {H ( j )}^{{r}_{j} + α \cdot {x}_{i}} , g )}{e ( {g}^{{r}_{j}} , H ( j ) ) \cdot e ( {H ( j )}^{{x}_{i}} , {g}^{α} )} ) )}^{1 / η} \\ = {( {\prod }_{j ∈ ρ} e ( {\tilde{g}}^{{x}_{i}} , g ) )}^{1 / η} \\ = {( {e ( \tilde{g} , g )}^{η \cdot {x}_{i}} )}^{1 / η} \\ = {e ( \tilde{g} , g )}^{{x}_{i}}\end{matrix}$$

where η is the total number of attributes in ρ.
Note: The use of η is optional. During the generation of the coin's share, if xᵢ has also been shared among the attributes used for the generation of the coin share, then η is not necessary in this function and one may use the Lagrange interpolation instead.
(b) Step 2-Reconstruct_{Coin} ( ): After constructing the share of the coins for at least t parties for the claimed set of attributes, the following is computed:

Πᵢ₌₁^{t}e(\tilde{g},g)^{x}^{ᵢ}^{λ}^{ᵢ}

where λᵢ represents Lagrange interpolation coefficients.

It will be appreciated that the invention also applies to computer programs, particularly computer programs on or in a carrier, adapted to put the invention into practice. The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a flash drive or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or to be used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A coin share generator for use in a system for performing a threshold coin tossing scheme, comprising
a coin determining unit for determining a coin value;
a coin share generating unit for generating a coin share based on the coin value and a private key associated with a set of attributes, the private key being obtained from a root authority, wherein the coin share is associated with the set of attributes by comprising a component for each attribute of the set of attributes and
a root authority subsystem, comprising
an attribute selector for selecting a set of attributes of an entity, wherein the set of attributes comprises a subset of a collection of attributes;
a key generating unit for generating the private key for use in a threshold coin tossing scheme, the private key begin associated with the set of attributes, the private key having secret key components, including secret key components related to the attributes in the set of attributes; and
a key distributor for providing the private key to a coin share generator.

2. The coin share generator according to claim 1, wherein the coin share generating unit is arranged for generating a coin share that enables a receiving entity to reconstruct the coin based on a particular threshold number of coin shares associated with a set of attributes that satisfies a predetermined policy over the attributes.

3. A coin share verifier for use in a system for performing a threshold coin tossing scheme, comprising
a coin share determining unit for determining a coin share to be verified, the coin share being obtained from a coin share generator as in claim 1, wherein the coin share is associated with a set of attributes; and
a coin share verifying unit for verifying a validity of the coin share, taking into account the set of attributes associated with the coin share.

4. The coin share verifier of claim 3, wherein the coin share verifying unit comprises an attribute verification unit for verifying that the coin share is validly associated with a particular attribute.

5. The coin share verifier of claim 3,
further comprising a policy determining unit for determining a policy over a collection of attributes, wherein the set of attributes comprises a subset of the collection of attributes; and
wherein the coin share verifying unit is further arranged for verifying whether the coin share is associated with a set of attributes that satisfies the policy.

6. The coin share verifier claim 3, further comprising
a share combining unit for reconstructing the coin by combining at least a predetermined threshold number of coin shares, wherein the coin shares are associated with respective sets of attributes that satisfy a predetermined policy over the attributes.

7. The coin share verifier of claim 3, wherein the coin share comprises an identification of the set of attributes associated with the coin share, and wherein the coin share is cryptographically processed using attribute-based cryptography.

8. A system for performing a byzantine fault tolerance protocol, comprising the root authority subsystem and the coin share generator and/or the coin share verifier of claim 3.

9. (canceled)

10. A workstation or a mobile terminal comprising the coin share generator, the coin share verifier and/or the system for performing a byzantine fault tolerance protocol according to claim 8.

11. A method of generating a coin share in a threshold coin tossing scheme, comprising
determining a coin value; and
generating a coin share based on a coin value and a private key associated with a set of attributes, the private key being obtained from method of generating a private key as in claim 15, wherein the coin share is associated with the set of attributes by comprising a component for each attribute of the set of attributes.

12. A method of verifying a coin share in a threshold coin tossing scheme, comprising
determining a coin share to be verified, wherein the coin share is associated with a set of attributes, the coin share being obtained from a method of generating a coin share as in claim 15; and
verifying a validity of the coin share, taking into account the set of attributes associated with the coin share.

13. The method according to claim 12, further comprising reconstructing the coin by combining at least a predetermined threshold number of coin shares, wherein the coin shares are associated with respective sets of attributes that satisfy a predetermined policy over the attributes.

14. A computer program product comprising instructions for causing a processor system to perform the method of claim 11.

15. A method of generating a private key for a threshold coin tossing scheme, comprising
selecting a set of attributes of an entity, wherein the set of attributes comprises a subset of a collection of attributes;
generating the private key associated with the set of attributes, the private key having secret key components, including secret key components related to the attributes in the set of attributes, and
providing the private key to a coin share generator.
